(19) United States
(12) Patent Application Publication
(10) Pub. No.: US 2009/0301354 A1
(43) Pub. Date: Dec. 10, 2009

(54) Method For Compacting A Hydraulic Binder And Novel Milled Pellets

(76) Inventors: Jean-Michel Faure, Oullins (FR); Corinne Fonquerne, Villeurbanne (FR); Emmanuel Garcia, Saint-Didier De La Tour (FR)

Correspondence Address: PILLSBURY WINTHROP SHAW PITTMAN, LLP, P.O. BOX 10500, MCLEAN, VA, 22102, US

(21) Appl. No.: 11/911,822

(22) PCT Filed: Apr. 14, 2006
(86) PCT No.: PCT/FR06/00820

§ 371 Date: Oct. 18, 2007

(30) Foreign Application Priority Data
Apr. 19, 2005 (EP) 052908867.0

(51) Int. Cl. C04B 7/02; C04B 7/52

(52) U.S. Cl. 106/726; 106/724

(57) ABSTRACT

A method of compressing a composition includes compacting a hydraulic binder in a quantity greater than 95% by weight and a disintegrating agent in a quantity less than or equal to 0.5% by weight, into compacts in a roller press. The milled pellet of a composition including a hydraulic binder in a quantity greater than 95% by weight and a disintegrating agent in a quantity less than or equal to 0.5% by weight.

### TECHNICAL FIELD

The invention relates to a method for compacting a hydraulic binder, in particular cement, by a dry process, as well as the resulting compacts which are finally milled. A subject of the invention is also a device for implementing the method.

### TECHNOLOGICAL BACKGROUND

Granulation and compaction of cement and other additives commonly used in the preparation of a concrete to improve flow and/or handling properties are known. In particular, granulation by a wet process and by a dry process (compaction) are known.

Granulation by a wet process is used to convert the cement into spherical granules of a size comprised between 500 μm and 3 mm. The method consists in spraying a binding solution onto the grains of cement moving in a mixer-granulator or a granulation bed, to induce agglomeration. This technology necessitates the use of a binder product and a binder dissolution solvent. In the case of cement, an alcohol and a (polymer) binder for example are used to obtain granules. Although with regard to the method, granulation produces good results, characterization of the granules obtained at different (polymer) binder ratios, however, shows that the use properties of a conventional cement are not reproduced when a granulated cement is used. In fact, the solvent and the (polymer) binder interact with the cement. Severely delayed setting and very significant reductions in strength are then noted according to the binder contents studied, as well as possible problems of redispersion of the granules in water for certain binder contents. On an industrial scale, this type of method also involves recycling equipment for the solvents, which is difficult to envisage in the cement industry due to the resulting additional costs and the safety measures required for an industrial site of this nature. U.S. Pat. No. 6,500,253 describes a method of granulation by a wet process of this type.

Dry compaction or compression is also known, according to the same patent U.S. Pat. No. 6,500,253, which consists of preparing a mixture of a cement and a disintegrating agent, then compacting this mixture in a suitable machine of the “tabletting” (or punch or isostatic) type.

The methods for compacting by a dry process must moreover be capable of providing a solution to all or some of the following points arising with cement, which is a very fine powder, very dusty and very hygroscopic:
reducing dust emissions and facilitating the flow properties (storage and handling), this is in itself the purpose of the compaction, while allowing
redispersibility in water, and
satisfactory mechanical properties of the concrete.

The methods of compaction or compression must therefore enable a compromise to be reached between solidity and redispersion, as these are two opposing effects which rely on the same inherent property, the porosity of the aggregate or of the pellet.

The Applicant has studied the methods of compression of powders, in particular the isostatic (or punch) type known as “tabletting”. The tabletting tests carried out by the Applicant have enabled tablets of cement to be obtained. But a technology of this type cannot be considered on an industrial scale. In fact, producing tablets which are acceptable with regard to solidity imposes processing conditions which are unsuitable for the press and for industrial production; the production yields obtained in this way are very low. Alternatively or cumulatively, it would be necessary to alter the properties of the cement by addition of additives, which would significantly increase the cost. It is therefore clear that the compression of the cement cannot be carried out by this method.

There is therefore a need for a method on an industrial scale for compacting or compressing the cement into a form which allows easy handling, while providing good redispersibility in water for supplying concretes which have undiminished mechanical properties.

### SUMMARY OF THE INVENTION

The invention therefore provides a method of compression of a hydraulic binder in a roller press into compacts, as well as a milled hydraulic binder pellet.

The invention relates more particularly to a method of compression of a composition comprising:
a hydraulic binder in a quantity greater than 95% by weight and
a disintegrating agent in a quantity less than, or equal to, 0.5% by weight,
   into compacts in a roller press.

Alternatively, it is possible according to the invention to compress a hydraulic binder into compacts in a roller press without the addition of disintegrating agents. In this case, it is advantageous to mill the compacts in a conventional mill or an equivalent device before the hydraulic binder is mixed (optionally with other materials such as sand and aggregates).

According to one embodiment, the compacts have a characteristic size comprised between 5 and 100 mm, preferably between 10 and 50 mm.

According to one embodiment, the method moreover comprises a step of milling the compacts into milled materials.

The milled materials have for example a characteristic size comprised between 40 μm and 10 mm, preferably between 500 μm and 6 mm.

According to one embodiment, the method moreover comprises a step of screening and a step of separating the fines and/or coarse particles which can possibly be generated in the course of the method.

According to one embodiment, the method moreover comprises a step of recycling the particles thrown out of the rollers, the fines and/or coarse particles separated en route to the compression step in a roller press, or any other powder which can be generated during the method.

According to one embodiment, the hydraulic binder is a cement, preferably a Portland cement.

According to one embodiment, the hydraulic binder comprises a disintegrating agent, preferably in a quantity less than or equal to 0.5% by weight.

According to one embodiment, the disintegrating agent is chosen from starch, in particular potato starch (sodium starch glycolate), corn starch, cross-linked polyvinylpyrrolidone (X-PVP or crospovidone), cellulose fibre, colloidal silica, microcrystalline cellulose, starch known as “carboxymethyl starch”, cross-linked carboxymethyl cellulose, cellulose derivatives of HEC and HPMC type and their mixtures, preferably from cross-linked polyvinylpyrrolidone and potato starch.

According to one embodiment, the roller press comprises two tangential counter-rotating wheels, one or both of these wheels having pockets or grooves.

A subject of the invention is also a device for compression of a hydraulic binder, comprising:
a roller press to produce compacts,
a mill for said compacts for producing milled materials and fines;
a screen for separating the fines and/or coarse particles and the milled materials; and
a recycling device for returning the fines and/or coarse particles to the roller press.

### BRIEF DESCRIPTION OF THE FIGURES

FIG. 1 is a diagram of a device according to the invention.

### DESCRIPTION OF EMBODIMENTS OF THE INVENTION

The invention is now described in greater detail in the following description.

The method on which the invention is based is a method for compaction or compression using a roller press or wheel press, or a method known as “bricketting”. This type of method, which has been known for a long time in other fields, is however conventionally associated with heterogeneity defects, which are the hardness of the external surface and the presence of a relatively soft core in the compacts (or sheets) obtained. Thus the Applicant is benefiting from precisely the conventional disadvantage of this technology in the context of managing the compromise between solidity and redispersion.

A roller press conventionally comprises two tangential wheels or rolls which move in counter-rotation. A single one or both or none of the wheels has/have pockets or grooves. The speed of the two wheels can be the same or different. The wheels can be driven rotationally by two motors or by a single motor with a transmission mechanism for the other wheel. A distributor or precompactor downstream of a feed hopper is situated at the level of the nip region of the two tangential wheels. This distributor can operate by gravity and/or more often can comprise a force feed, for example with an extrusion screw of the single-screw or double-screw type. The powder feed by the precompactor can be carried out vertically by gravity alone or by forced gravity (feed screw): in this case the rolls are positioned side by side. In another possible configuration, powder feed by the precompactor can be carried out horizontally and forcibly (feed screw): in this case the rolls are positioned one above the other. Adjustment of the pressure applied by the rolls on the powder can also be provided for.

Compacts (or sheets) of variable geometries and features can thus be obtained. The smooth or ribbed rolls result in the formation of compacts in the form of sheets, the size of which is associated with the width of the rolls (for the width), the gap between the rolls (for the thickness) and the fragility of the sheet, therefore the pressure applied (for the length). For example, sheets of 10×3×1 cm are possible. Rolls with pockets result in individual compacts of width and length corresponding to the size of the pockets, with a shape corresponding to the imprint of the pocket of each roll and generally having a plane of symmetry, and with a thickness corresponding to the gap between the rolls. For example, 25 mm long, 15 mm wide and 2 mm thick compacts can be obtained. Several geometries having a plane of symmetry and a generally rounded shape are possible, briquettes, pellets, oblongs, rods, etc. Preferably, the compacts can have a low slenderness ratio (which generally reduces the associated phenomena of attrition and generation of fines). The invention also allows the problem of “capping” to be avoided.

According to one embodiment, milling of the compacts (optionally in the form of sheets) is carried out. It is also possible to mill another type of compressed product which is not necessarily that of the invention. Therefore the invention also includes this milling of tablets or granules or compacts (or sheets), regardless of the method by which they were obtained. A milled material can have an additional advantage. In fact, it has a relatively small size, which cannot be obtained with other compression techniques. The compression method known as “tabletting” cannot be used for sizes of less than 5 mm in particular. Moreover, the quantity of fines in a milled (or remilled) material is generally less than that present in another type of product, as the particles having a weak bonding have been stripped away during milling and eliminated by screening. As in the case of the compact from which it can originate, the milled material has a low slenderness ratio, which reduces even more the phenomena of attrition and associated generation of fines.

The granules obtained after milling and screening have a characteristic size or dimension comprised between 40 μm and 10 mm, preferably between 500 μm and 6 mm.

The milling can be carried out in any mill known to a person skilled in the art, for example a rasp mill or a hammer mill.

The mill can be integrated downstream of the roller press. Typically, it can be situated under the press in such a way that the compacts (or sheets) fall into the mill. A prebreaker can optionally be provided between the press and the mill. This prebreaker can be for example a shaft provided with blades driven rotationally, either by the weight of the falling compacts or by a motor. The mill is in particular a rasp mill. Downstream of the mill is a screening unit, which carries out the separation. Generally, at this stage at least two or three fractions are recovered. In the case of three fractions, the first fraction comprises the particles of large size (coarse particles), the second fraction comprises the milled material sought and the third fraction comprises the fines. The first and third fractions are advantageously combined to be recycled. In the case of two fractions, the first fraction comprises the milled material sought and the second fraction comprises the fines. The second fraction is generally recycled. This recycling can be suitably performed by the feed circuit which also carries the powdery raw material for example fed in at the foot of the device. The fraction of the compacts sought is recovered by stockpiling and packaging. It is also possible to provide a mill which only delivers the fractions having a size of less than the maximum value for the size interval for the milled material, i.e. there would no longer be a first fraction (this is the case when there are only two fractions as described above).

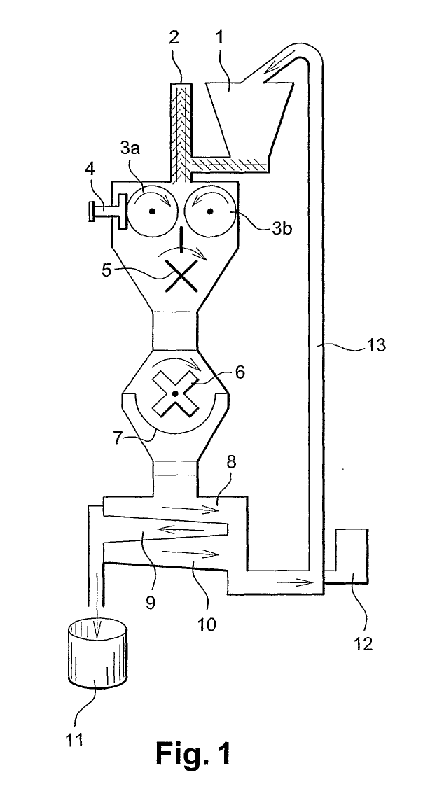

FIG. 1 is a diagrammatic representation of a device of this type. In this FIGURE, the references show the following elements described above:
1 feed hopper
2 double screw feeder
3a, 3b tangential wheels
4 pressure regulating device
5 prebreaker
6 mill
7 screen
8 first fraction zone
9 second fraction zone
10 third fraction zone
11 collector
12 powder feed
13 recycling and feed loop

The apparent bulk density of the shaped binder is slightly altered. While an apparent bulk density of powdered cement is 1.1 g/cm³, the apparent bulk density of the compacted products and the granules ((re) milled compacts) is respectively 1.27 g/cm³ and 1.25 g/cm³. The densification factor is therefore generally comprised between 1.1 and 1.4.

The hydraulic binder is any conventional binder and comprises for example (Portland) cement, gypsum, pozzolanas, slags, aluminous cements, etc. (Portland) cement is preferred. The method according to the invention can also be applied if necessary to the conventional constituents of concretes, such as for example fly ash, fumed silica, etc. These conventional constituents can also already be present in combination with the hydraulic binder; for example it is possible to have a compact comprising Portland cement combined with fumed silica, in variable proportions. Generally, the binder (most frequently a cement) constitutes the majority of the compact (more than 95% by weight for example), if not the entirety, with the exclusion of additives, in particular those mentioned below.

Compositions of hydraulic binder, in particular cement, in any form whatsoever, can comprise additives, preferably in a total quantity less than or equal to 0.5%. The following can be mentioned:
binding agents, which improve the coating and the bonding between the components of a heterogeneous material in order to give it cohesion;
lubricating agents, which are added to reduce the porosity of the particular structure and to promote bonding forces. Clogging problems are reduced and a smoother and more shiny appearance is given to the agglomerated product; and
disintegrating agents, which allow the disintegration of an agglomerate to be accelerated. The disintegration mechanism is purely physical. The additive swells in contact with the water; in turn it causes the agglomerate to swell and then burst.

It is preferred for the latter compound or disintegrating agent to be present to promote redispersion in water.

The disintegrating agent is not critical provided that the redispersion in water is effective. The cement is in fact redispersed during the mixing operation in the presence of aggregates of which the grains have an attrition effect, whether mixing in-factory or in a concrete plant is involved. Any disintegrating agent is generally suitable. As an example and non-limitatively, the following can be mentioned: starch, in particular potato starch (sodium starch glycolate), corn starch, cross-linked polyvinylpyrrolidone (X-PVP or crospovidone), cellulose fibre, cross-linked carboxymethyl cellulose, colloidal silica, microcrystalline cellulose, starch known as “carboxymethyl starch”, cellulose derivatives of HEC and HPMC type and their mixtures.

As a binding agent, polyethylene glycol and microcrystalline cellulose (apart from its role as a disintegrating agent) as well as polyvinylpyrrolidone can be mentioned.

As a lubricating agent, magnesium stearate and stearic acid can be mentioned.

Other additives can also be present in the products according to the invention. Plasticizers and superplasticizers, accelerators, air-entraining agents, etc. can be mentioned in particular.

### EXAMPLES

The following examples illustrate the invention without limiting it.

### Example 1

The press used was a tangential-wheel laboratory press with gravity feed. Compacts of approximately 25×10×5 mm in size were then milled in a rasp mill in order to obtain granules. A screening finally allowed granules of a size comprised between 500 μm and 3 mm to be obtained.

Various compositions were tested for the degree of strength of the final mortars. Compositions of the following type were used:

| Components | Quantity (g) |
|---|---|
| Silica sand 0-0.315 | 385 |
| Silica sand 0.315-1 | 1385 |
| Silica sand 1-4 | 980 |
| Cement CEM 32.5 R II/B | 623 |
| Mixing water | 105 |
| Lignosulphonate (solution of sodium salt) | 7 |
| Adjustment water | qsf slump 8-9, approx. 230 |

The cement was a CEM II/B 32.5 R cement, optionally with additives. The reference was a powdered cement (i.e. the control was a non aggregated cement).

The granules were tested on a laboratory scale. A conventional concrete mortar formula was used. A Perrier laboratory mixer was used.

The compositions were set up in such a way as to obtain a spread or “slump” value of 8-9 cm, as in the case of the physical mixtures. Measurement of strength values at 1 day and 28 days was carried out in a conventional manner.

For the two successive series of tests performed, the following results were obtained, using on the one hand cross-linked PVP (Luvicross®), and on the other hand corn starch (Starch 1500®), for two dosages, 0.5% and 1%. Tables 1 and 2 give the results for the cross-linked PVP and the corn starch, respectively.

TABLE 1

| Strength (MPa) | Reference | 1% | 0.5% |
|---|---|---|---|
| Bending 1 d | 2.57 | 2.30 | 2.57 |
| Compression 1 d | 9.38 | 9.10 | 9.65 |
| Bending 28 d | 7.60 | 6.85 | 7.18 |
| Compression 28 d | 43.95 | 37.53 | 39.06 |

TABLE 2

| Strength (MPa) | Reference | 1% | 0.5% |
|---|---|---|---|
| Bending 1 d | 2.68 | 2.54 | 2.60 |
| Compression 1 d | 8.90 | 8.04 | 8.23 |
| Bending 28 d | 7.31 | 7.22 | 7.52 |
| Compression 28 d | 40.85 | 37.07 | 39.58 |

The values for bending and compressive strength, at 1d and 28d, were therefore substantially identical between the reference and the products according to the invention containing 0.5% or 1% of disintegrating agent.

### Example 2

The press used was an industrial press and the mill is a rasp mill. The cement used was a CPA CEM II/B 32.5 R. The fraction of 1-6 mm granules was recovered after milling sheets. Compositions containing 0.5% of cross-linked PVP were prepared. Two different pressures were used on the machine, namely:

| | Pressure (bar) | Specific force (kN/cm) |
|---|---|---|
| P1 | 121 | 50 |
| P2 | 158 | 65 |

The granules were tested in standardized CEN mortar following the standardized EN 196-1 protocol. The control mix was based on powdered cement. The results are given in table 3 below.

TABLE 3

| Strength (MPa) | Reference | P1 | P2 |
|---|---|---|---|
| Compression 1 d | 10.4 | 12.8 | 10.1 |
| Compression 2 d | 17.8 | 15.5 | 13.7 |
| Compression 7 d | 32.3 | 33.0 | 29.1 |
| Compression 28 d | 41.3 | 45.6 | 39.2 |

The compressive strength values were thus substantially identical between the reference and the products according to the invention containing 0.5% of disintegrating agent.

### Example 3

A test on an industrial press was carried out in order to obtain briquettes. For this test, rolls with pockets, but without grooves, were used. The briquettes were 3 cm long, 1.5 cm thick and 2 cm wide. The mixture used for this shaping was cement with 0.5% of cross-linked PVP. A simple test of immersion of the briquette in water showed that redispersion takes place spontaneously; the water penetrating into the briquette through the more porous median zone (interface of the junction of the two hemispheres, resulting from each roll).

The briquettes were tested in standardized mortar in the same way as in Example 2, and were then compared to the reference. The results are given in Table 4 below.

TABLE 4

| Strength (MPa) | Reference | Briquette |
|---|---|---|
| Compression 1 d | 10.4 | 13.4 |
| Compression 2 d | 17.8 | 22.0 |
| Compression 7 d | 32.3 | 35.15 |
| Compression 28 d | 41.3 | 47.2 |

The values for compressive strength were therefore substantially identical between the reference and the products according to the invention containing 0.5% of disintegrating agent.

### Example 4

The granules or compacts according to the invention were tested in concretes of B25 type formulae:

| Components | Quantity (for 1 m³ of concrete) |
|---|---|
| Cassis aggregates 10-20 | 621 kg |
| Cassis aggregates 6-10 | 322 kg |
| Honfleur sand | 804 kg |
| Cement | 350 kg |
| Plasticizer Chryso 209 | 800 g |
| Water | qsf slump 13.5-14.5 cm |

The tests were carried out on a Zyklos 40 L concrete mixer. The mixing protocol is the following:
1) Introduction of the aggregates at t=0;
2) Between t=0 and t=30 s, addition of the pre-mixing water;
3) Until t=2 min 30, rest;
4) Between t=2 min 30 and t=3 min, introduction of the cement, whilst stopped;
5) Between t=3 min and t=3 min 30, introduction of the plasticizer and the remaining water during the mixing;
6) Between t=3 min 30 and t=5 min 30, mixing.

With regard to the cement, CEM II/A-S 52.5 N PM cement was used, either in the conventional powder form (control) or in the form of briquettes or granules containing 0.5% of cross-linked carboxymethyl cellulose (croscarmellose) and obtained by compaction at a pressure of approximately 195 bars (specific force of approximately 80 kN/cm). The compressive strength measurements for the concretes obtained with these different cements are given in Table 5 below.

TABLE 5

| | | Croscarmellose |
|---|---|---|
| Strength (MPa) | Control | briquettes |
| Compression 1 d | 14.4 | 13.7 |
| Compression 2 d | 20.7 | 19.2 |
| Compression 7 d | 32.3 | 31.5 |
| Compression 28 d | 42.4 | 40.0 |

The compressive strength values were therefore substantially identical between the reference and the products according to the invention containing 0.5% of croscarmellose as an additive.

1-17. (canceled)

18. A method of compressing a composition, the method comprising compacting a hydraulic binder in a quantity greater than 95% by weight and a disintegrating agent in a quantity less than or equal to 0.5% by weight, into compacts in a roller press.

19. The method according to claim 18, in which the compacts have a characteristic size comprised between 5 and 100 mm.

20. The method according to claim 18, in which the compacts have a characteristic size comprised between 10 and 50 mm.

21. The method according to claim 18, further comprising a step of milling the compacts into milled materials.

22. The method according to claim 21, in which the milled materials have a characteristic size comprised between 40 μm and 10 mm.

23. The method according to claim 21, in which the milled materials have a characteristic size comprised between 500 μm and 6 mm.

24. The method according to claim 18, further comprising a step of screening and a step of separating the fines or coarse particles which may be generated during the method.

25. The method according to claim 24, further comprising a step of screening and a step of separating the fines and coarse particles which may be generated during the method.

26. The method according to claim 18, further comprising a step of recycling the particles thrown out of the rollers, the fines and/or coarse particles separated en route to the step of compression in a roller press or any other powder which may be generated during the method.

27. The method according to claim 18, in which the hydraulic binder is a cement.

28. The method according to claim 18, in which the hydraulic binder is Portland cement.

29. The method according to claim 18, in which the disintegrating agent is chosen from starch, potato starch (sodium starch glycolate), corn starch, cross-linked polyvinylpyrrolidone (X-PVP or crospovidone), cellulose fibre, colloidal silica, microcrystalline cellulose, starch known as “carboxymethyl starch”, cross-linked carboxymethyl cellulose, cellulose derivatives of HEC and HPMC type and their mixtures.

30. The method according to claim 18, in which the disintegrating agent is chosen from cross-linked polyvinylpyrrolidone and potato starch.

31. The method according to claim 18, in which the disintegrating agent is cross-linked carboxymethyl-cellulose.

32. The method according to claim 18, in which the roller press comprises two tangential counter-rotating wheels, one or both of these wheels having pockets or grooves.

33. The milled pellet of a composition comprising:
a hydraulic binder in a quantity greater than 95% by weight and
a disintegrating agent in a quantity less than or equal to 0.5% by weight.

34. The milled pellet according to claim 33, having a characteristic size comprised between 40 μm and 10 mm.

35. The milled pellet according to claim 33, having a characteristic size comprised between 500 μm and 6 mm.

36. The milled pellet according to claim 33, in which the hydraulic binder is a cement.

37. The milled pellet according to claim 33, in which the hydraulic binder is Portland cement.

38. The milled pellet according to claim 33, in which the disintegrating agent is chosen from starch, potato starch (sodium starch glycolate), corn starch, cross-linked polyvinylpyrrolidone (xPVP or crospovidone), cellulose fibre, colloidal silica, microcrystalline cellulose, starch known as “carboxymethyl starch”, cross-linked carboxymethyl cellulose, cellulose derivatives of HEC and HPMC type and their mixtures.

39. The milled pellet according to claim 33, in which the disintegrating agent is chosen from cross-linked polyvinylpyrrolidone and potato starch.

40. The milled pellet according to claim 33, in which the disintegrating agent is cross-linked carboxymethyl-cellulose.
